(19) United States
(12) Patent Application Publication
(10) Pub. No.: US 2007/0035046 A1
(43) Pub. Date: Feb. 15, 2007

(54) Solar-powered downdraft aerator

(76) Inventor: David Allen Wensloff, Coarsegold, CA (US)

Correspondence Address: David Allen Wensloff, 40308 Greenwood Way, Oakhurst, CA, 93644, US

(21) Appl. No.: 11/499,382

(22) Filed: Aug. 4, 2006

Related U.S. Application Data
(60) Provisional application No. 60/707,826, filed on Aug. 15, 2005.

(51) Int. Cl. B01F 3/04

(52) U.S. Cl. 261/93; 261/120

(57) ABSTRACT

A highly efficient impeller apparatus for mixing concentrated oxygen in a liquid-filled pond, pool or lagoon. The downward and outward direction of liquid flow, coupled with optimally small bubbles produced through injection holes in tubes mounted on the impeller blades, optimizes the absorption of oxygen by the liquid. A rigid shroud surrounding the impeller constrains the liquid motion to axial, rather than radial, flow to ensure efficient mixing and minimize the electrical load requirements. The impeller drive may powered by a solar panel and battery combination, or by electrical utility service, or by a combination thereof.

### CROSS-REFERENCE TO RELATED APPLICATIONS

This application claims the benefit of Provisional Patent Application Ser. No. 60/707,826, filed 2005 Aug. 15 by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

The present invention relates to a circulation system for a body of liquid, most often water; specifically, the circulation system is designed to deliver a gas, most often pure oxygen, to the liquid and thoroughly mix very fine gas bubbles in it to produce a high concentration of the dissolved gas.

### BACKGROUND OF THE INVENTION—PRIOR ART

Many wastewater treatment plants rely on aerobic bacteria to consume and dispose of organic material in the wastewater stream. The wastewater stream is directed into treatment ponds where it is allowed to reside for a period of time sufficient for the bacteria to properly reduce the organic material present in the influent wastewater stream. Aerobic bacteria, by definition, require oxygen to survive, and when insufficient oxygen is present in the treatment ponds, anaerobic bacteria, which thrive in an oxygen-poor environment, can come to dominate the biological processes in the treatment ponds. This is undesirable because many anaerobic bacteria species produce various gases containing sulfur as byproducts of their life cycle, and those gases are a source of undesirable foul odors. To avoid those odors, wastewater treatment plants are compelled to take steps to maintain the oxygen level, measured as dissolved oxygen concentration,(D.O.), in their treatment ponds at a level sufficient to ensure the dominance of aerobic bacteria.

There are a number of methods for increasing D.O. in water. Oxygen from the air is naturally absorbed at the surface of a body of water, and the rate at which oxygen is dissolved can be increased by mixing, as happens in nature through waterfalls, streams, rain, and wind. Moreover, in a body of water such as a wastewater treatment pond, natural mixing can be improved upon substantially using aerators of various types. These aerators commonly operate by one of three methods: (1) a surface splashing action; (2) an aspirating effect that draws in atmospheric air and introduces it to the water as bubbles; or (3) compressing atmospheric air and releasing it at the bottom of the pond. All three of these methods tend to require high energy input, most frequently in the form of an electric motor to drive a splashing or rotating aerator or air compressor.

The use of floating pond aerators of various types is well established in prior art, as shown by U.S. Pat. No. 4,179,243 granted to Aide (Dec. 18, 1979), and U.S. Pat. No. 4,030,859 granted to Henegar (Jun. 21, 1977). In those patents, the aerator generates an upwelling of water from a predetermined depth to the surface. This upwelling brings oxygen-poor water to the surface to increase the natural rate of oxygen dissolution in the water, but that is the only mechanism employed. These aerators can be refined, as in U.S. Pat. No. 6,439,853 granted to Tormaschy, et al. (Aug. 27, 2002), to include a variety of circulatory aides intended to improve the efficiency of the aerator in circulating the water, but these aides still have minimal impact on oxygen transfer efficiency. Indeed, the declarations associated with these patents speak of a secondary purpose involving the regulation of temperature in order to prevent the pond or lake from freezing over during the winter.

Other prior art aerators, such as those disclosed by McWhirter, et al., in U.S. Pat. No. 6,860,631 (Mar. 1, 2005), work by both circulating water within the lagoon or pool, and by generating a spray of water droplets that entrain air during their flight, thereby providing a marked increase in oxygen transfer efficiency. This increase in transfer efficiency would obviously be greater if the electrical requirements of the aerator could be reduced. Moreover, prior art declarations for these types of splashing aerators focus on new aerator configurations that wring some fractional increase in efficiency out of existing concepts.

### BACKGROUND OF THE INVENTION—OBJECTS AND ADVANTAGES

The present invention takes an entirely different approach to improving oxygen transfer efficiency. A major source of oxygen transfer inefficiency in prior art declarations lies in their reliance on air as their oxygen source. Since air is only 21% oxygen (by volume), almost 80% of the energy expended with conventional aerators is wasted dissolving (or attempting to dissolve) nitrogen and other trace atmospheric gases. Therefore, the present invention relies upon the use of liquid oxygen to provide some of its improvement in oxygen transfer efficiency over prior art declarations.

Of course, the use of pure oxygen to maintain D.O. in wastewater treatment plants is well known in prior art, and the present invention does not focus on the use of pure oxygen as the source of its claims. Rather, the present invention incorporates the use of pure oxygen as one aspect among many in the invention. It is, therefore, an object of the present invention to utilize pure oxygen from a liquid oxygen tank as its source of oxygen, rather than utilizing atmospheric oxygen with the attendant waste of energy on atmospheric nitrogen.

It is also an object of the present invention to dispense pure oxygen gas into the water in the form of fine bubbles. Since diffusion of a gas into a liquid is constrained by the surface area of the gas-liquid interface, these fine bubbles provide a higher ratio of surface area to volume, offering a higher transfer efficiency than coarser bubbles for the same volume of oxygen.

It is also an object of the present invention to provide substantial and efficient circulation of the water in the body, to ensure that the benefit of the fine oxygen bubbles is spread throughout the body of water. This circulation of the water disperses oxygen-enriched water away from the aerator while simultaneously drawing oxygen-poor water toward the aerator for enrichment.

It is also an object of the present invention to circulate the water in such a manner as to prolong the contact time between the water and the fine oxygen bubbles as much as possible, since a longer contact time will yield greater oxygen transfer.

It is also an object of the present invention to utilize the fine bubbles and prolonged contact time to minimize the energy requirements of the mixing motor, allowing the motor to be powered by a solar panel array in locations where it is feasible.

### SUMMARY OF THE INVENTION

The aerator of this invention is a floating circulating device for use in a treatment pond, pool, or lagoon. The impeller is mounted below the surface of the water, oriented and operated to direct flow downward and away from the surface. Along the edges of the impeller blades are positioned small tubes, pierced in a manner to produce fine bubbles, and connected to the hollow impeller drive shaft. The drive shaft terminates at a drive block, to which the oxygen source is connected. The diffuser tubes inject oxygen gas into the water in fine bubbles, and these bubbles are rendered even smaller by the turbulence caused by the mixing impeller. The combination of fine bubbles and prolonged contact time offers excellent oxygen transfer efficiency with a comparatively small mixing motor.

### DRAWINGS—FIGURES

FIG. 1 is a side view of the present invention.

FIG. 2 is a bottom-up view of the present invention.

FIG. 3 is a plan view of the invention in its preferred embodiment and the facilities associated with the invention as installed.

FIG. 4 is a detailed view of the impeller, drive shaft, and bearing/distribution block showing the mechanism for keeping the assembly gas-tight.

### DRAWINGS—REFERENCE NUMERALS

1. impeller
2. shroud
3. floats
4. frame arms
5. frame vertical struts
6. frame horizontal struts
7. shaft
8. motor
9. attachment points
10. bearing/distribution block
11. electrical cord
12. gas tube
13. fitting
14. liquid
15. aerator
16. gas source
17. control panel
18. anchor post
19. solar panels
20. skirt
21. bearing surface
22. spring
23. impeller gas tubes
24. impeller diffusers
25. tethering cables
26. seal
27. locking collar

### DETAILED DESCRIPTION—PREFERRED EMBODIMENT AND OPERATION

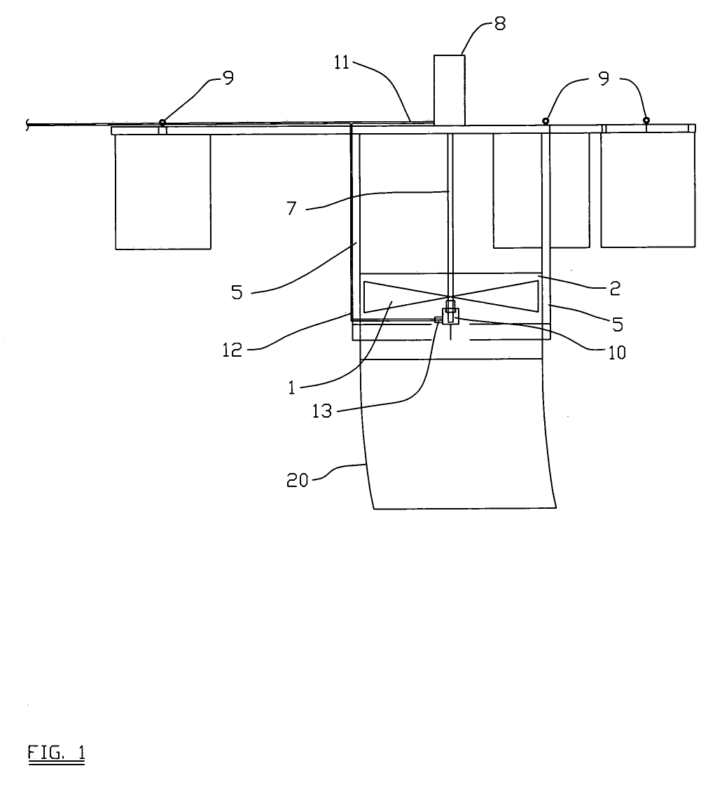

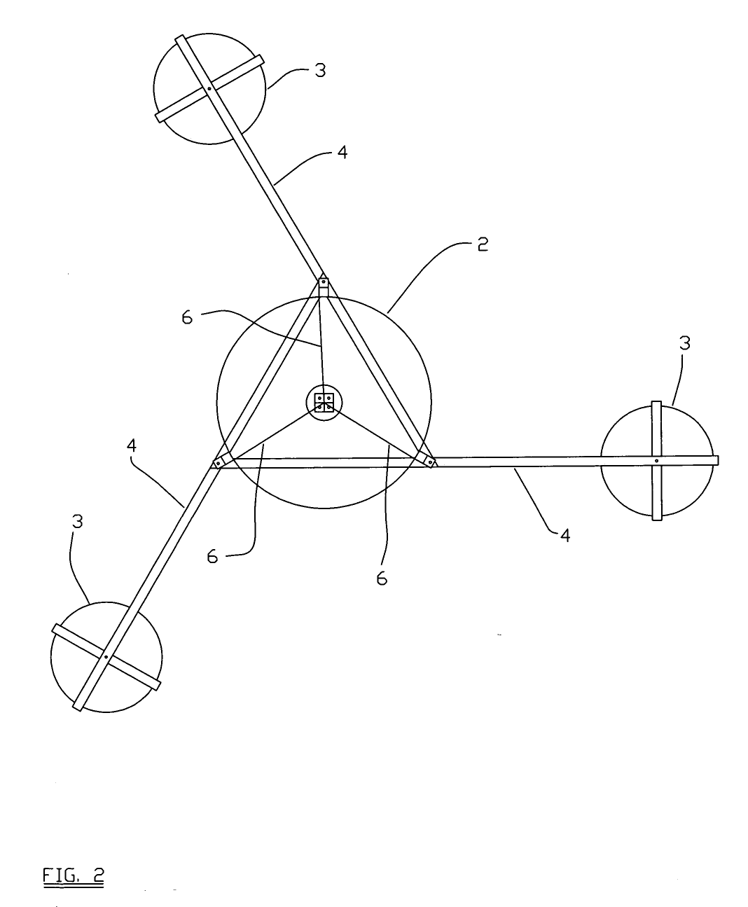

A preferred embodiment of the aerator system of the present invention is as follows: referring now to FIGS. 1, 2, and 3, impeller 1 is connected to motor 8 by shaft 7. Shroud 2 encloses impeller 1 to the sides, but not above or below, and impeller 1 is oriented and operated to draw liquid from above shroud 2 and propel it downward, out the bottom of shroud 2. The inner diameter of shroud 2 is only slightly larger than the diameter of impeller 1, to constrain liquid from escaping the influence of impeller 1 to the sides. Skirt 20 is attached to the bottom of shroud 2, and is sized to be long enough to reach the bottom of body of liquid 14. This allows the bottom of body of liquid 14, or some length of skirt 20 approximately parallel to the bottom, to ensure proper lateral circulation of liquid driven by impeller 1. Impeller 1, shroud 2, motor 8, and shaft 7 are supported by frame arms 4, frame vertical struts 5, and frame horizontal struts 6. Near the ends of frame arms 4 are a plurality of floats 3 to provide buoyancy when the aerator 15 is placed in a body of liquid 14, and a plurality of attachment points 9 for tethering aerator 15.

Oxygen gas from a gas source (a liquid oxygen gas tank or oxygen generator) 16 is conveyed to aerator 15 through gas tube 12 alongside electrical cord 11, which is connected to motor 8. Electricity is supplied by a plurality of solar panels 19 with battery backup, and routed through control panel 17. Gas tube 12 and electrical cord 11 are flexible and attached at one of a plurality of attachment points 9 to one of a plurality of tethering cables 25, each being connected to anchor posts 18. Tethering cables 25 maintain aerator 15 in the desired location in the body of liquid 14.

Gas tube 12 runs along one of the frame arms 4, then down one of the frame vertical struts 5, through a tight hole in shroud 2 located below impeller 1, and along one of the frame horizontal struts 6 to fitting 13 in bearing/distribution block 10.

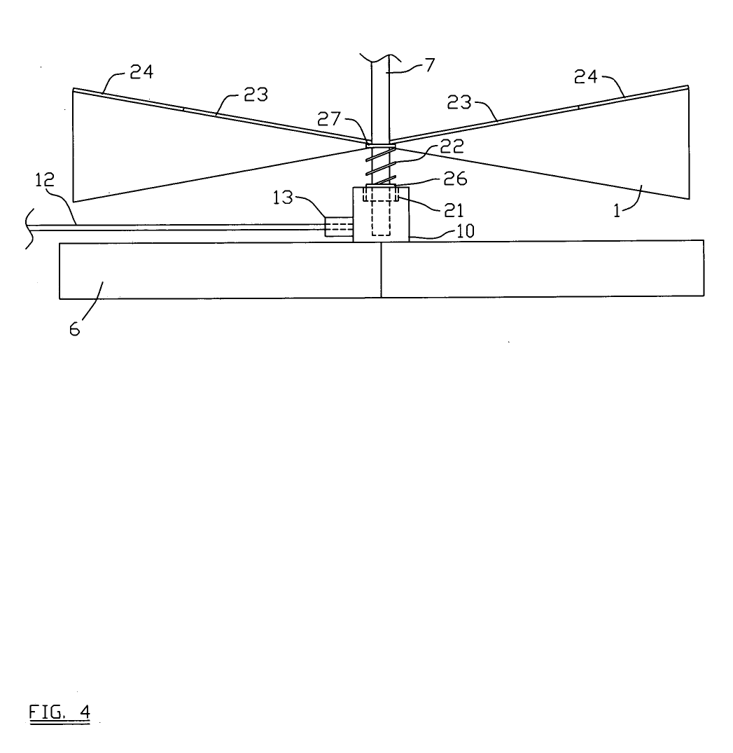

Impeller 1, the vital gas-tight connections involving gas tube 12 and block 10 are illustrated in greater detail in FIG. 4. Frame horizontal struts 6 provide rigid support to block 10. Block 10 has a hole bored into it through the upper surface to receive shaft 7 and bearing surface 21. A gas-tight connection around shaft 7 is maintained by the use of locking collar 27 on shaft 7, seal 26 and spring 22 to keep seal 26 tight against bearing surface 21. Shaft 7 is hollow with its upper end capped, so gas introduced to the interior of block 10 through gas tube 12 and fitting 13 will also fill the interior of shaft 7.

A plurality of impeller gas tubes 23 are tightly connected to holes drilled in shaft 7, and rigidly affixed to the leading edges of impeller 1. These impeller gas tubes 23 convey the gas to a plurality of impeller diffusers 24, from which the gas is dispensed into the liquid through very small holes in the skin of impeller diffusers 24.

The size of the gas bubbles is necessarily constrained by the size of the holes in impeller diffusers 24. Moreover, the location of impeller diffusers 24 along the leading edge of impeller 1 ensure that the turbulence introduced to liquid 14 by operation of impeller 1 will shear the gas bubbles into even smaller gas bubbles. Furthermore, since impeller 1 is oriented and operated so as to direct the circulation of liquid 14 downward and away from the surface of liquid 14, the gas bubbles introduced through impeller diffusers 24 will be in contact with liquid 14 for a longer period of time than if liquid 14 were being directed upward. This longer exposure will allow more gas to dissolve into liquid 14 and increase the efficiency of the aeration effort.

While the invention has been particularly shown and described, with reference to preferred embodiment thereof, it will be understood by those skilled in the art that various alterations in form and detail may be made without departing from the spirit and scope of the invention, and from the particular claims thereof. Therefore, it is not intended that the invention be limited to the specified preferred embodiment, but only as set forth in the appended claims.

### OPERATION —FIGS. 1, 2, 3, 4

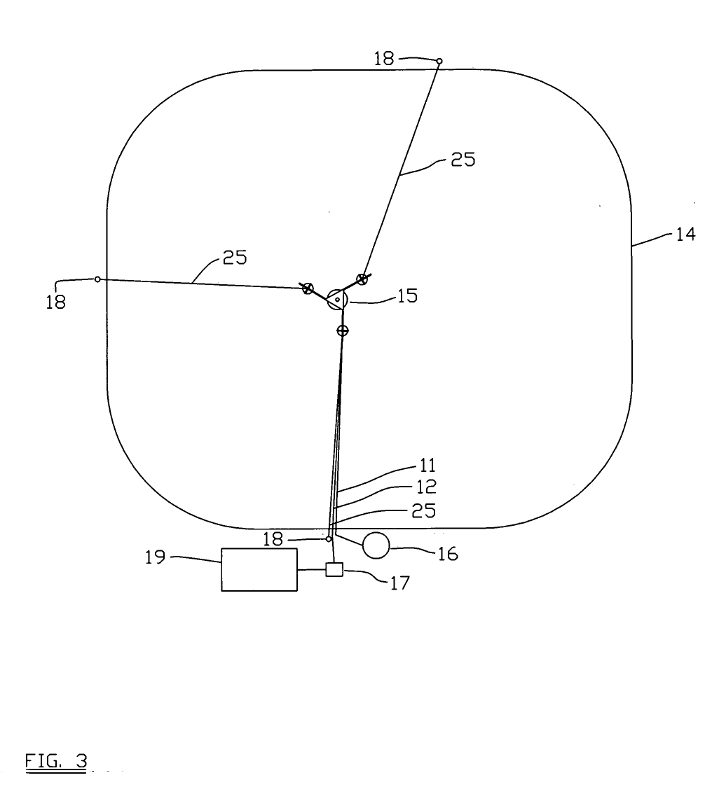

The operator situates aerator 15 in the body of liquid 14 so that it floats upon the surface of liquid 14. (FIG. 3) At each float 3 the operator connects tethering cable 25 from attachment point 9 to corresponding anchor post 18 on the shore.

The operator makes an oxygen connection from gas source 16 via gas tube 12 to fitting 13 with no detected leakage. The operator also makes an electrical connection from control panel 17 via electrical cord 11 to motor 8 with correct electrical polarity and insulation of all connections. Solar panels 19 (or batteries, not shown) are verified as providing electrical power by meter or other readings and monitored for safety.

The operator manipulates control panel 17 to activate motor 8, thus rotating impeller 1. The operator also releases gas pressure into impeller gas tubes 23 so that bubbles are ejected out of impeller diffusers 24 into liquid 14. As impeller 1 rotates, liquid 14 containing fine bubbles is directed downward and then outward from the bottom of shroud 2 and skirt 20. The operation of impeller 1 causes turbulence in liquid 14 that shears the gas bubbles even more finely.

Oxygen dissolves into liquid 14 during its contact below the surface; upon reaching surface of liquid 14, that oxygen not yet dissolved is released into the atmosphere.

The operator may vary the rate of circulation and thus absorption of oxygen by varying the electrical drive to motor 8 and pressure of gas being fed via gas tube 12, either by manual or automatic means. The operator may also monitor the oxygenation of liquid 14 in order to determine if variance is required.

The operator may reposition the aerator assembly by adjusting the length of tethering cables 25 in relation to anchor posts 18, which may also be relocated, to optimize or vary the effects of the circulation.

### CONCLUSION, RAMIFICATIONS, AND SCOPE

Accordingly, it is obvious that the present invention can be utilized to oxygenate a water treatment pond to maintain the D.O. level and prevent foul odors from developing. Where desired, the mixing and aerating functions can be employed individually, so that the motor could be turned on to circulate the water in a pond while leaving the oxygen flow off, or the motor could be left off and the oxygen flow turned on so the aerator acts as a fine-bubble diffuser. The aerator can also be utilized to mix other gases in other liquids. Moreover, the aerator has additional advantages in that
It allows aeration service to be installed in remote locations where electrical service is not available or would be expensive to install;
It places a lower total burden on electrical generating facilities than if the oxygen were generated on site, since centralized oxygen generation facilities are larger and realize better economies of scale than on site oxygen generation;
It is more efficient than if an air compressor were utilized to deliver air in place of oxygen;

Although the description above contains much specificity, this should not be construed as limiting the scope of the invention, but as merely providing illustrations of some of the presently preferred embodiments of this invention. For example, the motor could be installed as a fixed-speed motor, or it could be provided with controls to allow manual adjustment of the motor speed, or the controls to adjust the motor speed could be tied into one or more sensors that automatically adjust the motor speed to produce some programmed effect such as higher speed during the day and lower speed at night to minimize draw on the batteries. Oxygen flow controls could be provided to allow manual adjustment of the oxygen flow, or automatic flow controls could be provided and connected to one or more dissolved oxygen sensors within the pond, thereby adjusting the oxygen flow automatically in pursuit of a target D.O. level.

Thus the scope of the invention should be determined by the appended claims and their legal equivalents, rather than by the examples given.

Having described my invention in sufficient detail to enable those skilled in the art to make and use it, I claim as new and desire to receive Letters Patent for:

1. An aeration system for introducing a gas, in most cases pure oxygen, to a liquid in which said aeration system is placed, while simultaneously mixing said gas with said liquid and circulating said liquid within a pond, pool, lagoon, or other confines of said liquid, comprising:
a) an impeller to circulate said liquid within the confines of said liquid, said impeller oriented and operated so as to direct said liquid in a downward direction;
b) a drive system connected to said impeller;
c) a hollow shaft connecting said drive system to said impeller, said shaft to have a gas-tight cap on the upper end;
d) a plurality of small tubes arrayed along said impeller blades, said tubes having a plurality of very small holes through their walls at, or near, their ends, and to be pressurized with said gas so that said gas is forced through said holes to form very fine bubbles in said liquid; and
e) a bearing/distribution block that is hollow, otherwise gas-tight, and pierced in two places, once in an upper surface for said impeller shaft, and once in a side surface to accept a gas-tight fixture.

2. The aeration system of claim 1, wherein said impeller is surrounded on the sides, but not above or below, by a rigid shroud.

3. The aeration system of claim 2, wherein said shroud is essentially perpendicular to the surface of the liquid.

4. The aeration system of claim 2, wherein said shroud has an inner diameter only slightly larger than the impeller diameter.

5. The aeration system of claim 2, wherein said shroud prevents said liquid from escaping the influence of the impeller to the sides without interfering with the operation of said impeller.

6. The aeration system of claim 1, wherein said liquid, upon reaching the bottom of said pond, pool, lagoon, or other confines, then radiates outward, in a generally horizontal direction with respect to said shroud.

7. The aeration system of claim 1, wherein said liquid, upon reaching the sides of said pond, pool, lagoon, shroud or other confines, then rises upward with respect to said bottom of said pond, pool, lagoon, or other confines.

8. The aeration system of claim 1, wherein said impeller consists in part of said plurality of small tubes that are made of hollow gas-tight material, said tubes having a plurality of very small holes through their walls.

9. The aeration system of claim 1, wherein said impeller by its rotation against said very fine bubbles causes said very fine bubbles to be further reduced in size by the shearing action of the turbulent flow induced by said impeller.

10. The aeration system of claim 1, wherein absorption of said very fine bubbles is enhanced by extended time of exposure to said liquid before reaching said surface of said liquid.

11. The aeration system of claim 1, wherein said impeller and said shroud are supported by a frame.

12. The aeration system of claim 11, wherein said drive system is affixed to said frame.

13. The aeration system of claim 11, wherein said frame has attached to it a plurality of flotation devices to provide buoyancy when said aeration system is placed in said liquid.

14. The aeration system of claim 11, wherein said buoyancy afforded by said flotation devices is sufficient to support said drive system above the upper surface of said liquid, while simultaneously allowing complete submergence of said impeller and said shroud.

15. The aeration system of claim 11, wherein said frame incorporates a plurality of attachment points for anchoring or tethering systems for maintaining the approximate position of said aeration system while floating in said liquid.

16. The aeration system of claim 11, wherein said frame incorporates a connection device and tube to convey said gas from a gas source located on a shore to said gas-tight fixture in said bearing/distribution block.

17. The aeration system of claim 1, wherein said drive system is powered by a solar panel system located on said shore, said solar panel system to include both solar panels and batteries so as to store excess electricity generated during daylight hours in the batteries, for use during nighttime hours, thus enabling continuous 24-hour operation; whereby the coupling of said aeration system with said full time solar panel system will provide maximum performance at peak efficiency.

18. The aeration system of claim 1, wherein said drive system is powered by an electrical utility service as an alternative to solar panels.

19. The aeration system of claim 1, wherein said drive system is powered by an electrical utility service as a supplement to solar panels.
